(19) United States
(12) Patent Application Publication
(10) Pub. No.: US 2011/0192142 A1
(43) Pub. Date: Aug. 11, 2011

(54) FILTRATION DEVICE FOR EXHAUST GASES

(75) Inventors: Laurent Albert, Verderie (FR); Stephane Peyrazat, Le Mesnil-en-Thelle (FR)

(73) Assignee: VALEO SYSTEMES DE CONTROLE MOTEUR, Cergy Pontoise Cedex (FR)

(21) Appl. No.: 13/056,740

(22) PCT Filed: Jul. 31, 2009
(86) PCT No.: PCT/EP09/59947

§ 371 Date: Apr. 29, 2011

(30) Foreign Application Priority Data
Jul. 31, 2008 (FR) 0804364

(51) Int. Cl. F01N 3/021; F02M 25/07; F01N 3/023

(52) U.S. Cl. 60/274; 60/278

(57) ABSTRACT

The filtration device (12) for exhaust gases from a heat engine, characterized in that it includes filtration means (14, 19) adapted to treat the gases circulating between a particulate filter (8) and an exchanger EGR.

### FIELD OF THE INVENTION

The invention relates to the field of heat engines. It relates more particularly to the recirculation of the exhaust gases at the intake, commonly called “EGR” (exhaust gas recirculation).

### BACKGROUND OF THE INVENTION

In a heat engine, the EGR systems are used to reinject a portion of the exhaust gases toward the intake in order in particular to reduce the pollutant emissions, and do so by virtue of a recirculation duct linking the exhaust duct to the intake duct. In the heat engines that are fitted with a turbocharger and a particulate filter, it is known, according to a so-called “low pressure EGR” architecture, to have such a recirculation duct between the outlet of the particulate filter and the inlet of the compressor.

However, splinters of particulate filter (in general, of the ceramic) may be torn from the latter in particular during the initial hours of operation. Also, the particulate filter may crack in operation, the consequence of which is the emission of soot at the outlet of the latter. These particulate filter splinters and such soot are made to circulate in the recirculation duct and in the compressor clogging and even damaging the element present on the recirculation duct, such as exchangers or control valves, and the vanes of the compressor.

The document WO2008/007808 proposes detecting in the recirculation duct the presence of damaging bodies deriving from the particulate filter and, in the action, closing the recirculation duct. The recirculation of the exhaust gases is then no longer operational.

The document WO2006/126993 proposes providing in particular a turbocharger for which the vanes of the compressor are reinforced in order to withstand the passage of the damaging bodies deriving from the particulate filter, which increases the cost of the turbocharger.

The document DE10113449 finally proposes linking the recirculation duct upstream of the air filter in order for the latter to also filter the damaging bodies deriving from the particulate filter. As a variant, provision is made to place an additional filter between the exchanger arranged on the recirculation duct and the compressor.

### OBJECT OF THE INVENTION

The aim of the invention is to provide an economical and durable solution which protects the recirculation duct and the compressor against harmful bodies originating from the particulate filter.

### BRIEF DESCRIPTION OF THE INVENTION

To this end, the invention targets a filtration device for exhaust gases from a heat engine, characterized in that it includes filtration means adapted to treat the gases circulating between a particulate filter and an exchanger EGR. The device can include a body having an exhaust gas inlet, an outlet for evacuating exhaust gases and an EGR outlet; and can also include a filtering medium positioned between the exhaust gas inlet and the EGR outlet.

Such a filtration device makes it possible to protect all the elements of the recirculation duct and the compressor at a lower cost. It offers three circulation pathways (one inlet and two outlets) making it possible to position it advantageously between the exhaust duct and the recirculation duct.

The head losses induced by the presence of the filter can be reduced by leaving the pathway free between the inlet for the exhaust gases and the outlet for the exhaust gases, in particular when the body is an annular piece designed to be arranged inside the exhaust duct, such that the filtration device is designed to perform a first filtration by enabling the exhaust gases to pass through it from side to side without passing through the filtering medium.

According to other preferred characteristics, taken alone or in combination:
the EGR outlet includes an orifice formed on the periphery of said body in the form of an annular piece;
the body includes a central channel opening out on either side of the body, one of the opening ends of this central channel defining said exhaust gas inlet and the other of the opening ends of this central channel defining said outlet for evacuating the exhaust gases;
the body is a tube whose wall, which is hollow, encloses the filtering medium and the empty central space of which constitutes said central channel;
the tubular-shaped body includes an upstream flange and a downstream flange linked by a first cylinder forming the internal periphery of said hollow wall and defining said central channel;
the body also includes a second cylinder forming the external periphery of said hollow wall, this second cylinder including an orifice defining the EGR outlet;
the device includes means of sampling the exhaust gases circulating in the central channel, these means being designed to direct said sampled gases toward the EGR outlet via the filtering medium;
the sampling means include perforations formed in the first cylinder and the filtering medium is positioned coaxially around this first cylinder;
the device includes means of sampling the exhaust gases in proximity to the downstream flange, these means being designed to direct said sampled gases toward the EGR outlet via the filtering medium;
the sampling means include perforations formed in the downstream flange and the filtering medium is arranged in tubes each centred on a perforation;
the body includes a cone converging toward the exhaust gas inlet;
the filtering medium has a cone shape diverging from the outlet for evacuating exhaust gases, the two cones converging toward one another and being linked at an opening.

Another object of the invention targets an exhaust gas recirculation system for heat engine, comprising:
an exhaust duct for the heat engine, provided with a particulate filter
an intake duct for the heat engine
an EGR duct linked by one of its ends to the exhaust duct, downstream of the particulate filter, and by its other end to the intake duct
   characterized in that it also comprises a filtration device as described hereinabove, arranged in the exhaust duct in proximity to the outlet of the particulate filter, and in that the EGR duct is linked to the EGR outlet of the filtration device.

This system may also include filter regeneration means based on temperature rise, these regeneration means acting periodically on the particulate filter and on said filtration device.

Filter regeneration means based on temperature rise are commonly employed to clean the particulate filters.

These are known methods according to which, for example, the exhaust gases are ignited so that the particulate filter, which is in contact with these exhaust gases, sees its temperature raised to more than 600° C. in order to provoke the combustion of the particulates that are trapped therein. Such a regeneration is triggered usually periodically, for example every 1000 kilometres, in order to avoid clogging of the particulate filter.

Here, the regeneration of the particulate filter is exploited so as to also regenerate the filtration device intended for the recirculated gases.

To this end, another object of the invention targets a method of cleaning the filtration device of a system as described hereinabove, characterized in that it comprises the step of regenerating the particulate filter by temperature rise, this regeneration resulting in the cleaning of the filtration device.

### BRIEF DESCRIPTION OF THE DRAWINGS

The invention will be better understood in light of the following description of an exemplary preferred and nonlimiting implementation, the description being given with reference to the appended drawings, in which:

FIG. 1 is a schematic view of an engine architecture provided with a “low pressure” recirculation system;

FIG. 2 is a schematic view of a first embodiment of a filtration device according to the invention;

FIGS. 3a, 3b and 3c are perspective views of a filtration device according to a variant of the first embodiment;

FIG. 4 is a schematic view of a second embodiment of a filtration device according to the invention;

FIGS. 5a, 5b and 5c are perspective views of a filtration device according to a first variant of the second embodiment;

FIGS. 6a, 6b and 6c are perspective views of a filtration device according to a second variant of the second embodiment;

FIGS. 7a, 7b and 7c are perspective views of a filtration device according to a third variant of the second embodiment.

### DETAILED DESCRIPTION OF THE INVENTION

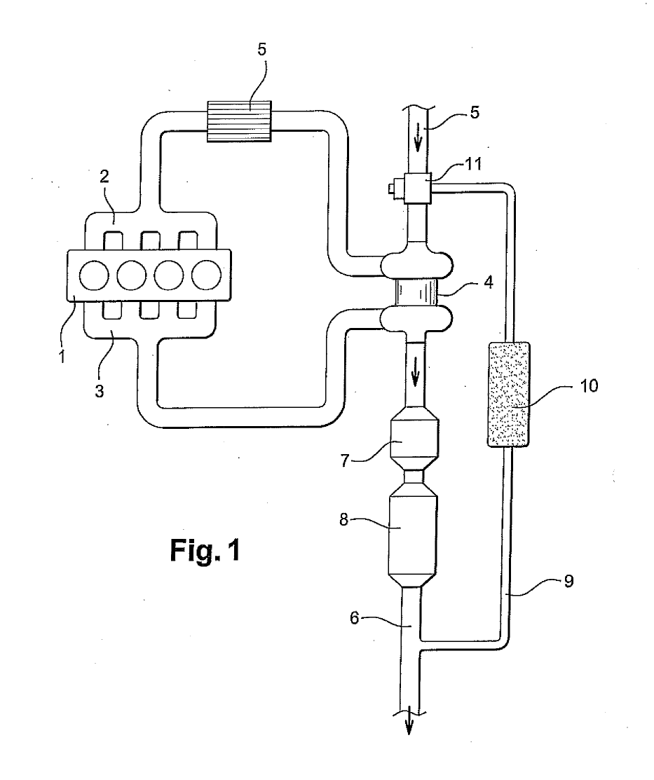

FIG. 1 schematically represents an engine architecture provided with a so-called “low pressure” exhaust gas recirculation system. The engine 1 is fed with cool gases via an intake manifold 2 and expels its burnt gases into an exhaust manifold 3. A turbocharger makes it possible to compress the intake gases by being driven by the exhaust gases. An intake exchanger 5 is used to lower the temperature of the intake gases. An intake duct 5 feeds the compressor of the turbocharger 4 with cool air whereas an exhaust duct 6 evacuates the burnt gases at the outlet of the turbine of the turbocharger 4 letting them pass through a catalyst 7 and a particulate filter 8.

The recirculation system is used here to sample the exhaust gases downstream of the particulate filter 8, via a recirculation duct 9 on which is arranged an EGR exchanger 10 and an EGR control valve 11.

According to the invention, there is provided a filtration device arranged between the particulate filter 8 and the EGR exchanger 10. This device is described in more detail hereinbelow.

The terms “upstream” and “downstream” used in the present description always refer to the direction of flow of the gases in the ducts.

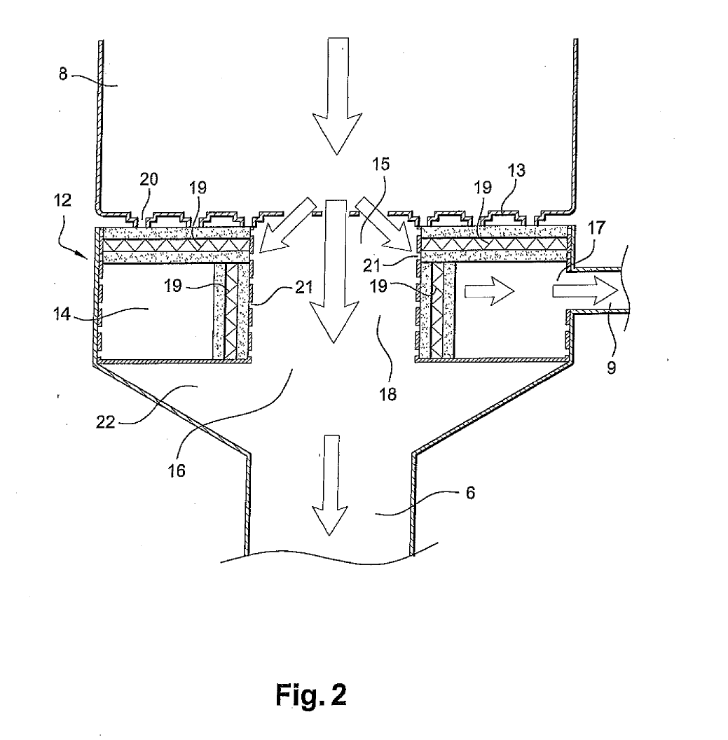

FIG. 2 shows a first embodiment of the filtration device 12 by a schematic view in longitudinal cross section. The downstream end of the particulate filter 8 can be seen in this figure and its outlet is schematically represented by the dotted line 13.

The filtration device 12 comprises an annular body 14 that has an exhaust gas inlet 15, an exhaust gas evacuation outlet 16, and an EGR outlet 17 linked to the recirculation duct 9.

The annular body 14 defines a central channel 18, the inlet of which corresponds to the exhaust gas inlet 15 and the outlet of which corresponds to the exhaust gas evacuation outlet 16. This annular body 14 also encloses a filtering medium 19 arranged against the downstream wall 20 and/or against the wall 21 of the central channel 18. These walls that receive the filtering medium are adapted to allow the exhaust gases to enter and are represented by dotted lines. They may be perforated, provided with a grating or any other porous means.

The exhaust gases leaving the particulate filter 8 pass through the central channel without being disturbed by the filtering medium, which reduces the head losses associated with the presence of the filtration device 12. Moreover, of the damaging bodies intended to be discarded from the recirculation duct 9, the largest bodies pass directly through the central channel by being driven by the speed of the exhaust gases, which allows for a first filtering.

The exhaust gases intended to be recirculated in the duct 9 are sampled from the exhaust gas flow via the walls 20 and/or 21 associated with the filtering medium 19. This second filtering then eliminates the finest particulates so that the recirculated gases no longer entrain particulates that are damaging to the components of the EGR circuit or to the turbocharger.

The filtration device 12 is in this case arranged against the outlet 13 of the particulate filter 8 and a convergent 22 provides the link between the filtration device 12 and the exhaust duct 6.

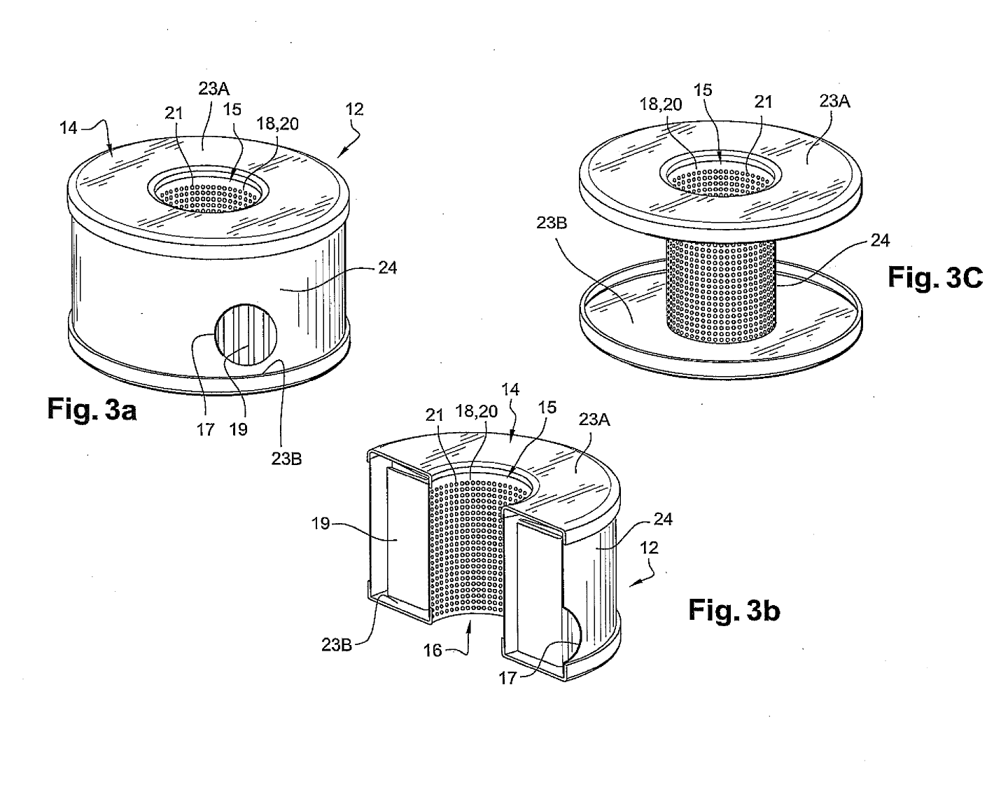

A variant of this embodiment is represented in FIGS. 3a to 3c. According to this variant, the exhaust gases intended to be recirculated are sampled only on the wall of the central channel 18.

The same reference number in the figures is used for each element common to the different embodiments and variants.

In these FIGS. 3a to 3c, the annular body 14 of the filtration device 12 is produced by two circular flanges 23A, 23B holed at their centre and linked together, at the centre, by a perforated cylinder 21 and, at the periphery, by a cylinder 24 on which a single opening defines the EGR outlet 17. The links can be made by welding, by fit or by any other known means.

The filtering medium is arranged concentrically to the cylinders 21 and 24 so that the exhaust gases intended for the recirculation are sampled at the cylinder 21, pass through the filtering medium 19 and leave via the EGR outlet 17.

The body 14 is therefore in this case a tube with hollow wall (the thickness of the wall being defined by the distance between the cylinders 21 and 24), the empty central space of which constitutes the central channel 18 and the hollow wall of which encloses the filtering medium 19. The cylinder 24 defines the external periphery of this hollow wall of the tube, whereas the cylinder 21 defines its internal periphery.

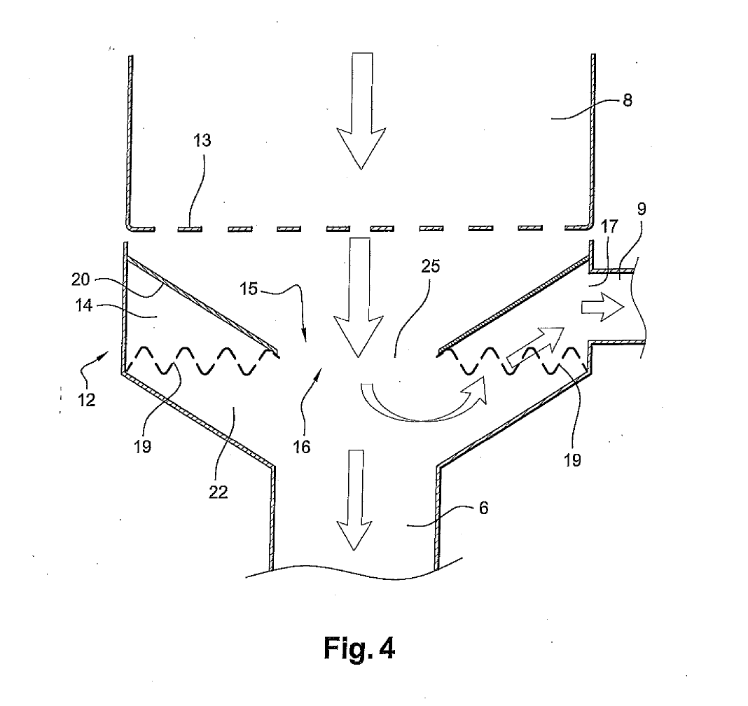

Referring to FIG. 4 and the following figures, a second embodiment will now be described. According to this embodiment, the exhaust gases intended for the recirculation are sampled only downstream of the exhaust flow.

In FIG. 4, which is a schematic view in cross section representing this second embodiment, the body 14 of the filtration device in this case comprises a downstream wall 20 which is not perforated and which channels all the exhaust flow toward a central opening 25. The filtering medium 19 is arranged between this opening 25 and the periphery of the body 14.

The exhaust gases thus pass through the opening 25 toward the exhaust duct 6, as in the first embodiment, and a portion of these gases is in this case sampled at the filtering medium 19, that is to say, after having changed direction of flow. The exhaust gases intended for the EGR are thus constrained to return backward via a chicane, which further enhances the first filtering.

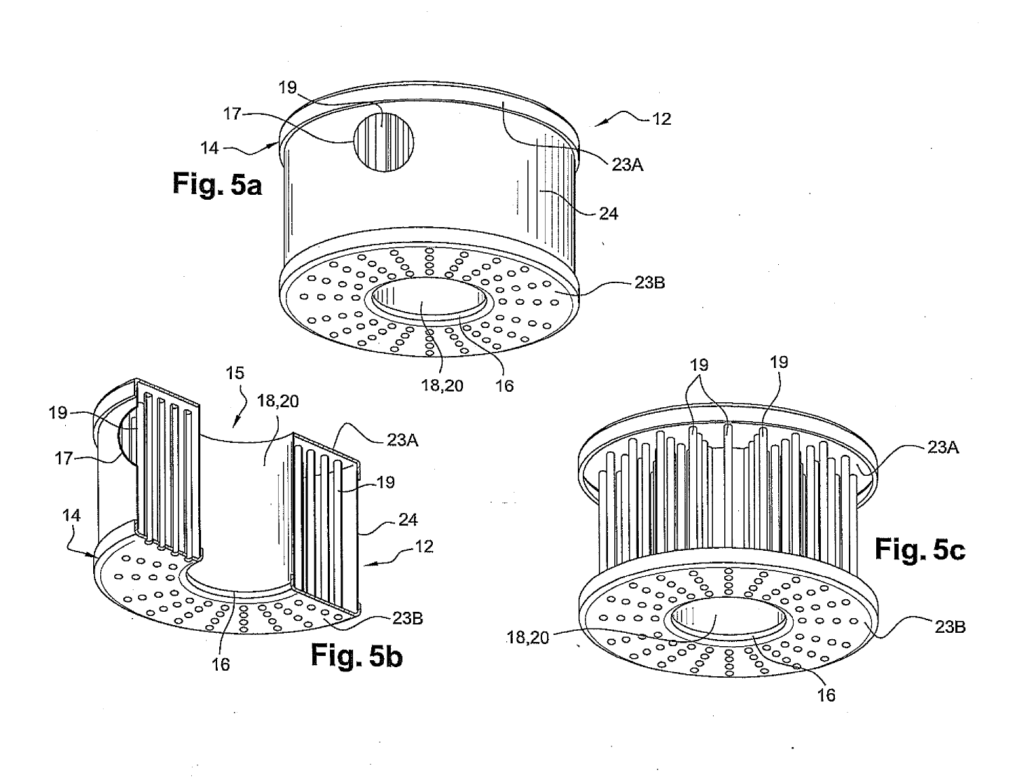

A first variant of this embodiment is represented in FIGS. 5a to 5c. The filtration device 12 in this case comprises a body 14 with a structure identical to that of FIGS. 3a to 3c except that the cylinder 21 is not perforated and the downstream flange 23B is perforated.

For each of the perforations of the downstream flange 23B, the filtering medium 19 is arranged in tubes, only one end of which opens out, the latter being centred on the corresponding perforation (see FIG. 5b).

The filtration device 12 according to the second embodiment makes it possible to perform a sampling of exhaust gases from the downstream flange 23B by forcing the gases intended for the EGR to execute a half-turn relative to the exhaust flow.

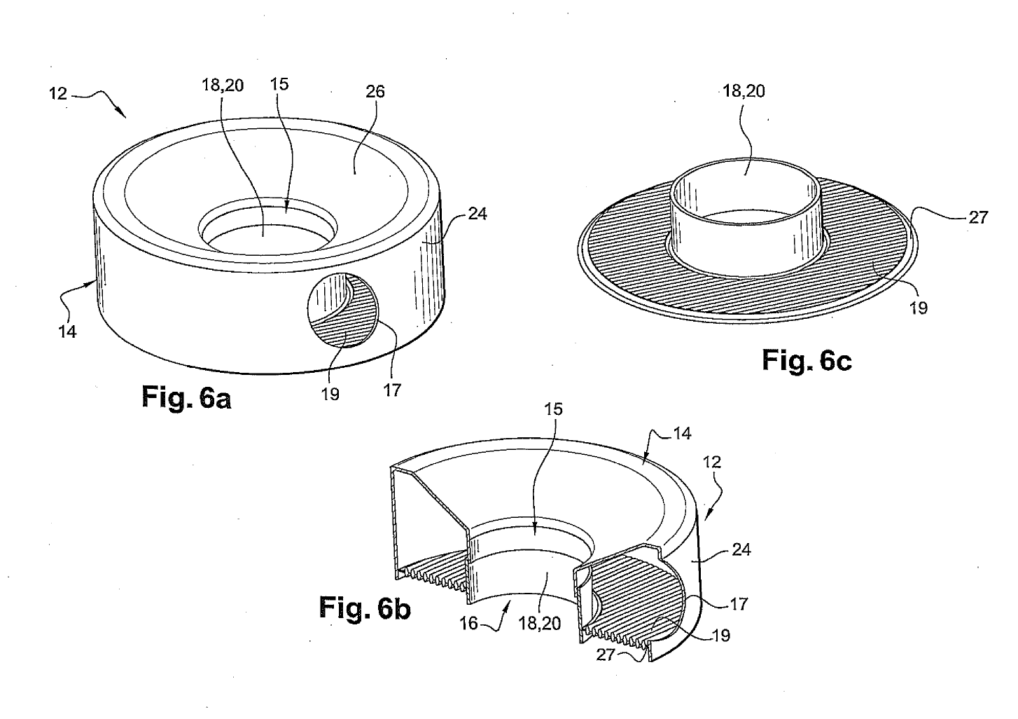

FIGS. 6a to 6c represent a second variant of the second embodiment. The body 14 is in this case formed by a convergent cone 26 linked to an external cylinder 24 and linked to an internal cylinder 21 that is not perforated.

The filtering medium 19 is mounted on a rigid annular frame 27 and this assembly in this case acts as downstream flange while allowing for the sampling of exhaust gases according to the second embodiment.

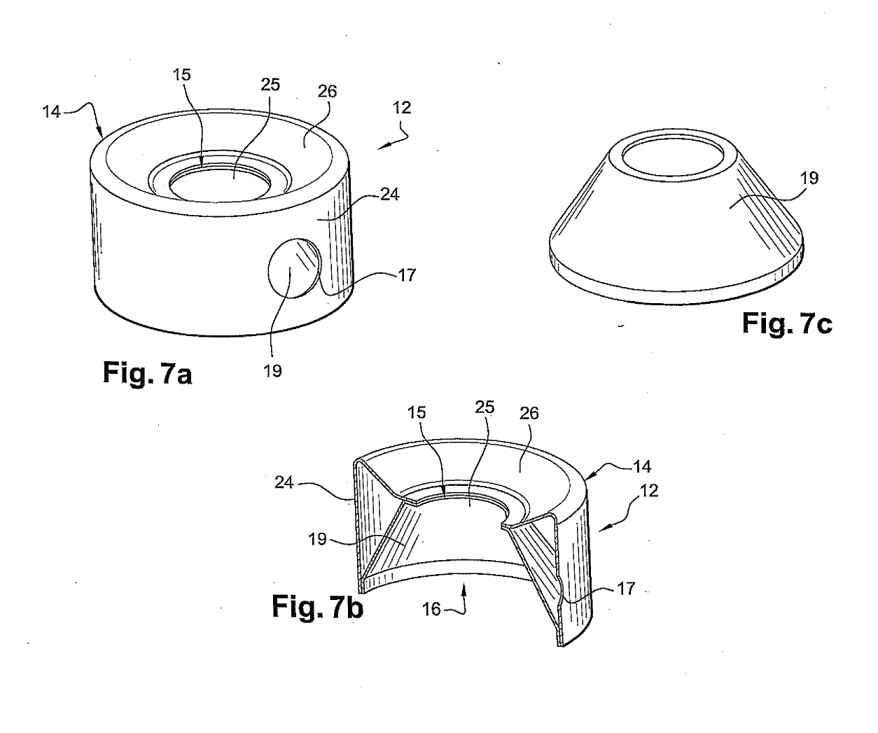

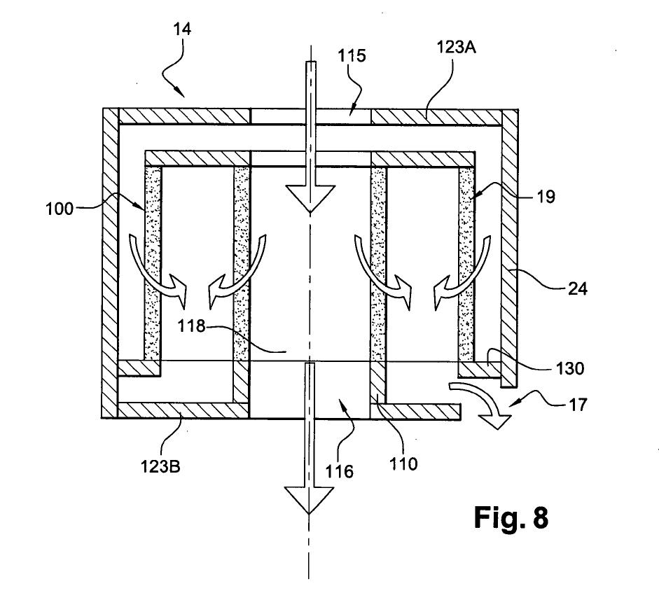

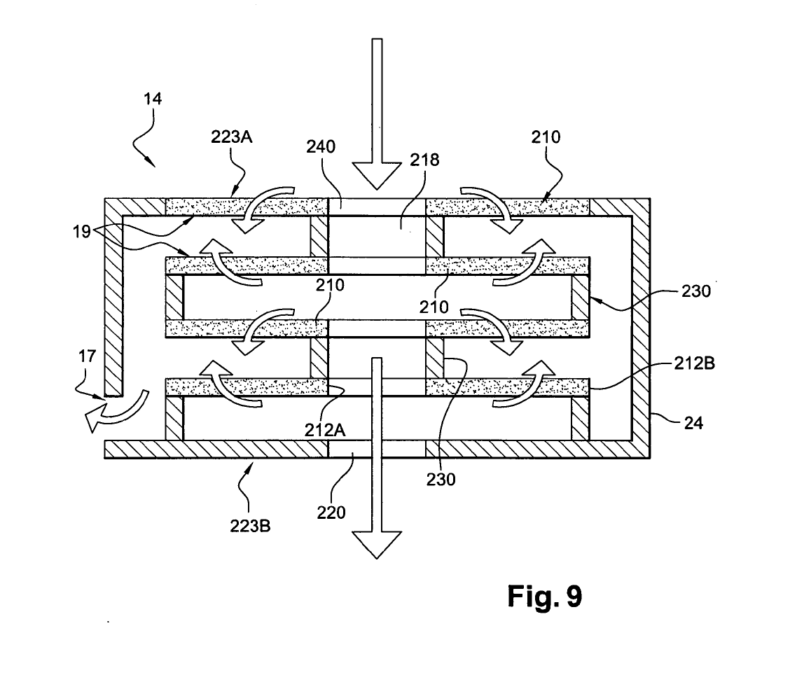

Referring to FIG. 7, a third variant of this second embodiment also provides for a convergent cone 26 linked to an external cylinder 24 for the production of the body 14. However, the body 14 does not include other components and the filtering medium, in divergent cone form, is directly linked to the convergent cone 26 over the entire circumference of the opening 25. The periphery of the divergent cone formed by the filtering medium is also linked over its entire circumference to the downstream circumference of the external cylinder 24.

The opening 25 in this case constitutes both the exhaust gas inlet and the exhaust gas evacuation outlet.

Moreover, for each of the variants of this second embodiment, it should be noted that, if the filtration device 14 is turned over in its housing (which amounts to reversing upstream and downstream), it then becomes compliant with the first embodiment.

The filtration devices 14, when they are arranged in proximity to the outlet of the particulate filter 8 as is the case in FIGS. 2 and 4, can easily be cleaned, that is to say, stripped of the impurities accumulated in the filtering medium 19, during the regeneration of the particulate filter 8.

By any known means, the temperature of the exhaust gases is increased until the particulate filter reaches a temperature above 600° C. so as to proceed with its regeneration in the conventional manner. Since the filtration device is placed in the exhaust duct 6, in proximity to the outlet of the particulate filter 8, its temperature is also raised to a value above 600° C. and the impurities contained in the filtering medium 19 are therefore burnt.

The filtration device 14 and the particulate filter can be encapsulated in one and the same module. This module would then have an exhaust gas inlet, an exhaust gas evacuation outlet and an EGR outlet.

Regarding the filtering medium 19, as for the other components of the filtration device, they may be constituted by any material suitable for withstanding the regeneration temperature.

Other embodiments can be envisaged without in any way departing from the context of the invention. In particular, the different embodiments and variants can be combined. For example, the convergent cone 26 may or may not be used in each of the embodiments described.

1. A filtration device for exhaust gases from a heat engine, comprising:
filtration means for treating the exhaust gases circulating between a particulate filter and an exchanger EGR.

2. The filtration device as claimed in claim 1, further comprising:
a body having an exhaust gas inlet, an outlet for evacuating the exhaust gases and an EGR outlet; and
a filtering medium positioned between the exhaust gas inlet and the EGR outlet.

3. The filtration device as claimed in claim 2, wherein the body is an annular part designed to be positioned inside an exhaust duct of the heat engine, wherein the body is configured to perform a first filtration by enabling the exhaust gases to pass through from side to side, without passing through the filtering medium.

4. The filtration device as claimed in claim 3, wherein the EGR outlet includes an orifice formed on the periphery of said body in the form of an annular piece.

5. The filtration device as claimed in claim 2, wherein the body comprises a central channel opening out on either side of the body, wherein one of the opening ends of the central channel defines said exhaust gas inlet and the other of the opening ends of the central channel defines said outlet for evacuating the exhaust gases.

6. The filtration device as claimed in claim 5, wherein the body is a tube comprising a hollow wall for enclosing the filtering medium, and wherein empty central space of the tube constitutes said central channel.

7. The filtration device as claimed in claim 6, wherein the tubular-shaped body comprises an upstream flange and a downstream flange linked by a first cylinder forming the internal periphery of said hollow wall and defining said central channel.

8. The filtration device as claimed in claim 7, wherein the body further comprises a second cylinder forming the external periphery of said hollow wall, wherein the second cylinder comprises an orifice defining the EGR outlet.

9. The filtration device as claimed in claim 7, further comprising means of sampling the exhaust gases circulating in the central channel, such means being configured to direct said sampled gases toward the EGR outlet via the filtering medium.

10. The filtration device as claimed in claim 9, wherein the sampling means include perforations formed in the first cylinder and wherein the filtering medium is positioned coaxially around the first cylinder.

11. The filtration device as claimed in one of claim 7, further comprising means of sampling the exhaust gases in proximity to the downstream flange, such means being configured to direct said sampled gases toward the EGR outlet via the filtering medium.

12. The filtration device as claimed in claim 11, wherein the sampling means include perforations formed in the downstream flange and wherein the filtering medium is arranged in tubes, each of which is centered on a perforation.

13. The filtration device as claimed in claim 2, wherein the body comprises a cone converging toward the exhaust gas inlet.

14. The filtration device as claimed in claim 13, wherein the filtering medium comprises a cone shape diverging from the outlet for evacuating exhaust gases, the two cones converging toward one another and being linked at an opening.

15. An exhaust gas recirculation (EGR) system for a heat engine, comprising:
an exhaust duct for the heat engine, provided with a particulate filter;
an intake duct for the heat engine;
an EGR duct linked by one end to the exhaust duct, downstream of the particulate filter, and by another end to the intake duct; and
a filtration device as claimed in claim 2, arranged in the exhaust duct in proximity to an outlet of the particulate filter,
wherein the EGR duct is linked to the EGR outlet of the filtration device.

16. The EGR system as claimed in claim 15, further comprising filter regeneration means based on temperature rise acting periodically on the particulate filter and on said filtration device.

17. A method of cleaning the filtration device of a system as claimed in claim 15, comprising:
regenerating the particulate filter by temperature rise, resulting in cleaning of the filtration device.
